(19) United States
(12) Patent Application Publication
(10) Pub. No.: US 2019/0371068 A1
(43) Pub. Date: Dec. 5, 2019

(54) Tap to Add Photo to Object in Augmented Reality

(71) Applicant: Peter George Mavronicolas, Conifer, CO (US)

(72) Inventor: Peter George Mavronicolas, Conifer, CO (US)

(21) Appl. No.: 16/292,362

(22) Filed: Mar. 5, 2019

Related U.S. Application Data
(63) Continuation of application No. 62/679,773, filed on Jun. 2, 2018.

(51) Int. Cl. G06T 19/00; G06F 3/0484; G06F 3/0482; G06F 3/0488; G06F 16/58; G06F 16/54

(52) U.S. Cl. CPC G06T 19/006; G06F 3/04845; G06F 16/54; G06F 3/04883; G06F 16/5866; G06F 3/0482

(57) ABSTRACT

The ‘Tap to Add Photo to Object in Augmented Reality’ invention allows smartphone application users to upload photos from their smartphone onto an object in augmented reality. The user taps on the screen of the smartphone directly over the object in the augmented reality view. The tap gesture switches the view to the smartphone's photo library. Once a photo is chosen, the smartphone view changes back to the augmented reality view with the chosen photo displayed.

### CROSS-REFERENCE TO RELATED APPLICATIONS

The ‘Tap to Add Photo in Augmented Reality’ invention is referenced in the Provisional Utility Patent Application No.: 62/679,773.

### BACKGROUND OF THE INVENTION

The initial use of the ‘Tap to Add Photo to Object in Augmented Reality’ invention is demonstrated in the iOS Application Listing AR which is published in the iOS AppStore. Listing AR is an iOS application that allows users to create real estate listings to be viewed in Augmented Reality. The ‘Tap to Add Photo to Object in Augmented Reality’ invention can also be used in social media applications where the user wishes to upload a photo from their smartphones ‘Photo Library’ and onto an object in the augmented reality view.

### BRIEF SUMMARY OF THE INVENTION

The tap to add photo to object in augmented reality allows users to upload photos to objects viewed in Augmented Reality. Problems prior to the existence of the ‘Tap to Add Photo to Object in Augmented Reality’ invention were that users wishing to create real estate listings were limited to uploading photos to be viewed individually rather than part of a model. Prior to this invention, users had to contact a realtor and meet in-person in order to walk through a house. With the ‘Tap to Add Photo to Object in Augmented Reality’ invention, users are now able to walk through several real estate listings in one day without having to leave their current location. The invention of the ‘360 view’ used by real estate applications is also limited in the capabilities of the ‘Tap to Add Photo To Object in Augmented Reality’ invention by being limited to stationary y and z coordinates and only being able to move about the x-axis. The ‘Tap to Add Photo To Object in Augmented Reality’ invention is capable of moving freely through the Augmented Reality view to include x, y, and z directions as demonstrated in augmented reality applications.

### BRIEF DESCRIPTION OF DRAWINGS

FIG. 1. In the top left image, the user taps on the screen of the smartphone directly over the object where the photo will display. In the middle image, the photo from the user's ‘photo library’ on their smartphone is selected. In the right image, the photo is displayed on the object in the augmented reality view.

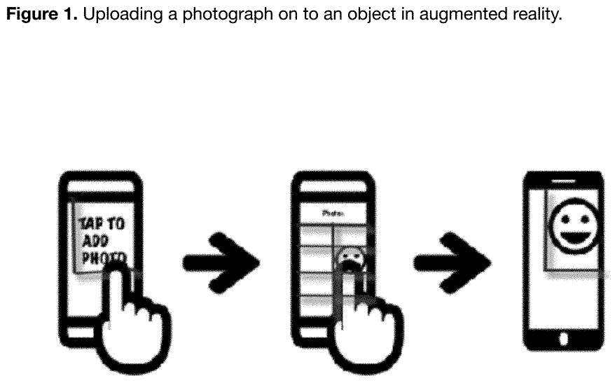

FIG. 2. (Below) FIG. 2 demonstrates how to use the “Tap to Add Photo to Object in Augmented Reality” invention. In the top left image, the user taps on the screen over the object. In the top middle image, the user selects the photo of a kitchen to be displayed on the object. In the top right image, the photo is displayed on the image. Also, the user taps on a second object. In the bottom right image, the user selects a second photo of a wooden floor. In the bottom left image, the second photo of a wooden floor is displayed as a hardwood floor in the augmented reality view.

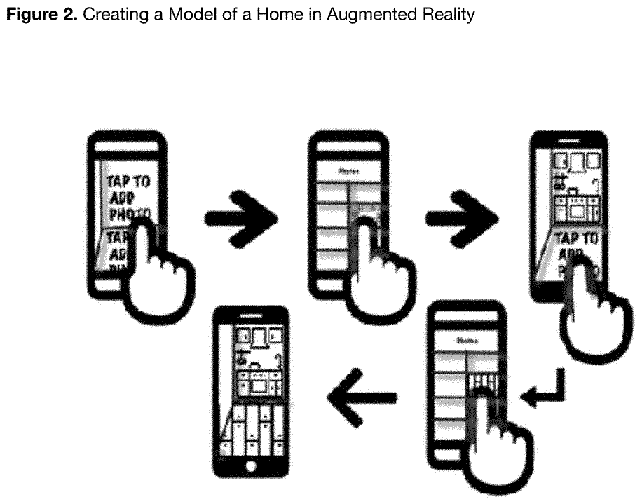

### DETAILED DESCRIPTION OF THE INVENTION

The ‘Tap to Add Photo to Object in Augmented Reality’ invention is designed to be used in augmented reality applications where the user wishes to upload photos to be rendered onto an object or plane in the augmented reality field of view. A script, the ChangeTexture.cs script, is called when a user taps the screen of a smartphone over the object or prefab model containing the texture and ChangeTexture.cs script. The ‘Tap Gesture’ initiates the smartphone to transition to the ‘Photo Library’ contained within each user's smartphone. Once a photo is selected from the ‘Photo Library’, the screen immediately transitions back to the augmented reality application. At this point, the chosen photo from the ‘Photo Library’ is now rendered onto the object or plane that was tapped on and contains the texture and ChangeTexture.cs script as published within the Listing AR iOS Application.

The Augmented Reality view is rendered by referencing the Main Camera from the UnityARCameraManager.cs script and ARCameraManager Game Object as published within the Listing AR iOS Application. The ‘Tap to Add Photo in Augmented Reality’ invention uses the C♯ (C Sharp) programming language in Unity 3D. The libraries used to access the functionality of the script are: System.Collections, System.Collections.Generic and UnityEngine. Photographs are rendered onto a texture attached to an object. Prior inventions have been used in Virtual Reality applications but never capable of performing the same capabilities in Augmented Reality.

1. The ‘Tap to Add Photo to Object in Augmented Reality’ invention is capable of uploading photographs from your smartphone to be displayed on an object within an Augmented Reality view.

2. The ‘Tap to Add Photo to Object in Augmented Reality’ invention is capable of uploading photographs from your smartphone to be rendered onto prefab models of apartments, houses, condos and office buildings and displayed in an Augmented Reality view.

3. The ‘Tap to Add Photo to Object in Augmented Reality’ invention is capable of uploading photographs from your smartphone to be rendered onto prefab models as well as objects to be displayed in an Augmented Reality view.
